(19) United States
(12) Patent Application Publication
(10) Pub. No.: US 2008/0241346 A1
(43) Pub. Date: Oct. 2, 2008

(54) Dog or cat food bar containing ellagitannin complexes or compounds from natural sources to reduce or prevent tumor development (benign or malignant) in cats or dogs

(76) Inventor: Robert D. Bibb, Myrtle Beach, SC (US)

Correspondence Address: Robert D. Bibb, M.D., 7554 Siena Blvd., Myrtle Beach, SC, 29572, US

(21) Appl. No.: 11/728,301

(22) Filed: Mar. 26, 2007

(51) Int. Cl. A23K 1/00

(52) U.S. Cl. 426/635

(57) ABSTRACT

A cat or dog food bar containing ellagitannin compounds to reduce or prevent a dog or cat's chance of developing a benign or malignant tumor.

### 1. FIELD OF THE INVENTION

The present invention relates generally to organic polyphenolic compounds, naturally occurring in certain plants and fruits, and their incorporation into processed dog and cat food bars for animal consumption. These bars will be constituted with sufficient quantities of the natural polyphenols known as ellagitannins to act as cancer preventive agents.

### 2. BACKGROUND OF THE INVENTION

It can generally be appreciated that the number one cause of death in dogs is death by tumor (benign or malignant).¹ It is likely that the same is true of cats. It can also generally be appreciated that dogs and cats consume primarily meat and meat related products. Certain proprietary dog and cat foods as well as pet treats may contain anti-oxidants but are lacking in specific compounds that have shown to be cancer preventive. These compounds are known as polyphenols and more specifically are included in a class of compounds called ellagitannins. ¹ BN Bonnett et al. Mortality in over 350,000 Insured Swedish dogs from 1995-2000: 1.Breed-, Gender-, Age and Cause-specific Rates. Acta Veterinaria Scandinavica.2005; 46(3): 105-120.

Peer reviewed research using ellagitannins obtained from natural sources has indicated that these polyphenolic compounds may have benefit in preventing or controlling certain tumors.^{2 3 4 5 6 7 8 9 10 11 12 13} ² Ratnam D V et al. Role of antioxidants in prophylaxis and therapy: A pharmaceutical perspective. J. Control Release. 2006 Jul. 20; 113(3):189-207.³ Ray A. Cancer preventive role of selected dietary factors. Indian J. Cancer. 2005 Jan.-Mar.; 42(1): 15-24.⁴ Li T M et al. Ellagic acid induced p53/p21 expression, G1 arrest and apoptosis in human bladder cancer T24 cells. Anticancer Res. 2005 Mar.-Apr.:25(2A):971-9.⁵ Seegram N P et al. In vitro antiproliferative, apoptotic and antioxidant activities of punicalagin, ellagic acid and a total pomegranate tannin extract are enhanced in combination with other polyphenols as found in pomegranate juice. J. Nutritional Biochemistry, 2005 Jun.; 16(6): 360-7.⁶ Adams L S et al. Pomegranate juice, total pomegranate ellagitannins and punicalagin suppress inflammatory cell signaling in colon cancer cells. J. Agric Food Chemistry, 2006 Feb. 8; 54(3):980-5.⁷ Aggarwal B B et al. Molecular targets of dietary agents for prevention and therapy of cancer.Biochem. Pharmacology, 2006 May 14; 71(10):1397-421.⁸ Stoner G D et al. Protection against esophageal cancer in rodents with lyophilized berries: potential mechanisms. Nutr. Cancer, 2006; 54(1):33-46.⁹ Paivarinta et al. Ellagic acid and natural sources of ellagitannins as possible chemopreventive agents against intestinal tumorigenesis in the Min mouse. Nutr Cancer, 2006; 54(1):79-83.¹⁰ Whitley et al. Site specific accumulation of the cancer preventive dietary polyphenol ellagic acid in epithelial cells of the aerodigestive tract. J Pharm Pharmacol. 2006 Sep.; 58(9): 1201-9.¹¹ Mertens-Talcott S U et al. Induction of cell death in Caco-2 human colon carcinoma cells by ellagic acid rich fractions from muscadine grapes (Vitis rotundifolia)J Agric Food Chem.2006 Jul. 26; 54(15):5336-43.¹² Han D H et al. Antioxidant and apoptosis-inducing activities of ellagic acid. Anticancer Res 2006 Sep.-Oct.; 26(5A):3601-6.¹³ Tanimura S et al. Suppression of tumor cell invasiveness by hydrolysable tannins (plant polyphenols) via the inhibition of matrix metalloproteinase-2/−9 activity .Biochem Biophys Res Commun. 2005 May 20; 330(4): 1306-13.

### SUMMARY OF THE INVENTION

The invention will consist of food bars containing any all possible combinations of food materials suitable for consumption for cats or dogs with sufficient quantities of natural ellagitannins to act as both tumor suppressive and preventive agents. Said food bars will designed for different weight categories of cats and dogs. The invention will consist of any and all natural materials found to contain effective ellagitannin compounds and will include ellagitannins found in any and all varieties of grapes, raspberries and pomegranates.

### DETAILED DESCRIPTION OF THE PREFERRED EMBODIMENTS

The present invention is a new cat or dog food bar designed specifically to reduce or prevent tumor formation (benign or malignant) in the aforementioned species of animals. With respect to the above description, it is to be realized that the optimum quantity of ellagitannins compounds incorporated into any given food bar will vary according to the natural plant or fruit chosen. And; therefore, the foregoing description should be illustrative of the principles of the invention. Further, since numerous modifications and changes will occur in the exact composition of the food bars, it is not desired to limit the invention to an exact description of weight quantities of active ingredients and accordingly, all suitable modifications and equivalents that may be resorted to should be included in the scope of this invention.

What is claimed is:

1. Certain polyphenolic compounds known as ellagitannins may reduce or prevent a dog or cat's chance of developing tumors (benign or malignant).

2. That I have invented a dog or cat food bar containing ellagitannin complexes or compounds from natural sources that will be available to reduce or prevent tumor development (benign or malignant) in cats or dogs.
